(19) United States
(12) Patent Application Publication
(10) Pub. No.: US 2025/0042040 A1
(43) Pub. Date: Feb. 6, 2025

(54) DEVICE AND METHOD FOR THE AUTOMATED PRODUCTION OF SCREW CONNECTIONS

(71) Applicant: HELLA GmbH & Co. KGaA, Lippstadt (DE)

(72) Inventors: Ingo ENGLER, Soest (DE); Frank JAGOW, Erwitte (DE); Tobias MERKENDORF, Lippstadt (DE); Miguel LEBRATO-RASTROJO, Paderborn (DE); Felix RAMME, Geseke (DE); Thomas Albert ROEBBECKE, Erwitte (DE)

(73) Assignee: HELLA GmbH & Co. KGaA, Lippstadt (DE)

(21) Appl. No.: 18/790,128

(22) Filed: Jul. 31, 2024

(30) Foreign Application Priority Data
Jul. 31, 2023 (DE) 10 2023 120 300.2

(51) Int. Cl. B25J 11/00; B25J 15/00; B25J 15/04

(52) U.S. Cl. CPC B25J 11/005; B25J 15/0019; B25J 15/045

(57) ABSTRACT

A device for the automated production of screw connections. An articulated arm robot has an output element and an end member. A screwdriving tool unit is rotatable about an effector axis via the output element. A profile shaft with a screw blade arranged at the end of it and a hub. The profile shaft and the hub are connected to each other in a form-fitting manner in the circumferential direction. The profile shaft can be displaced along the effector axis relative to the hub. A linear drive unit is mounted at the end member and comprises a working element which can be driven to an axial displacement parallel to the effector axis. A fastener is rigidly connected to the working element and connected to the profile shaft by a rotary bearing so that the profile shaft can be displaced along the effector axis by the linear drive unit.

This nonprovisional application claims priority under 35 U.S.C. § 119(a) to German Patent Application No. 10 2023 120 300.2, which was filed in Germany on Jul. 31, 2023, and which is herein incorporated by reference.

### BACKGROUND OF THE INVENTION

### Field of the Invention

The present invention relates to a device for the automated production of screw connections and a method based on this device for the automated production of screw connections.

### Description of the Background Art

The publications DE 10 2020 126 189 A1 (which corresponds to US 2023/0271332) and DE 10 2020 127 488 A1 (which corresponds to US 2023/0356371), which are all herein incorporated by reference, disclose devices for the automated production of screw connections based on articulated arm robots, in which the end member (6th axis) of the articulated arm robot itself is used to drive a screwdriving tool, dispensing with the automatic screwdriving machines otherwise conventionally used as process heads. The screwdriving process carried out in this way is based on an (infinite) rotation of the screwdriving tool by means of the end member and a simultaneous feed of the screwdriving tool by means of an appropriate movement of the articulated arm robot.

When using conventional devices, the cycle time in the automated production of screw connections is limited by the kinematic performance and positioning accuracy of the articulated arm robot. A special problem exists with the robot-guided retraction movement of the screwdriving tool after the screwdriving process has been completed, wherein an undesirable jamming of the screw blade with the screw head can occur.

### SUMMARY OF THE INVENTION

It is therefore an object of the present invention to provide a further development of a device and a method for the automated production of screw connections, which are based on the concept of using the output element of an articulated arm robot to drive a screwdriving tool known from the above-mentioned publications, and in particular enable more robust and faster operation.

In an example, a device if provided for the automated production of screw connections, comprising an articulated arm robot with an output element and an end member, wherein the output element is arranged on the end member so as to rotate about an effector axis. A screwdriving tool unit can be rotated about the effector axis by means of the output element, wherein the screwdriving tool unit comprises a profile shaft with a screw blade arranged at the end of it and a hub, wherein the profile shaft and the hub are connected to each other in a form-fitting manner in the circumferential direction, and wherein the profile shaft can be shifted along the effector axis relative to the hub. A linear drive unit is mounted on the end member and comprises a working element which can be driven to an axial displacement parallel to the effector axis. A fastener is rigidly connected to the working element and is connected to the profile shaft by means of a rotary bearing, so that the profile shaft can be displaced along the effector axis by means of the linear drive unit.

The invention is based on the idea of enabling the device to displace the screw blade independently of the articulated arm robot, so that the cycle time of the screwdriving process is not limited by the kinematics of the articulated arm robot, but rather that an expedient axial displacement of the screw bit relative to the end member of the articulated arm robot, which is driven by the linear drive unit, occurs when the screw is driven in and the screw blade is subsequently released from the screw. The concept quoted above of using the output element of the articulated arm robot to (infinitely) rotate the screw blade is retained.

The displaceability of the screw blade can be based on the implementation of a hub-shaft concept, wherein the screw blade is mounted or molded at the end of the shaft, and wherein the shaft is designed in the form of a profile shaft, for example a splined shaft or a toothed shaft, and is mounted in a hub with a complementary inner profile. As a result, the profile shaft can be shifted in the axial direction, i.e., along the effector axis of the articulated arm robot, relative to the hub, while at the same time a form-fitting connection is formed between the profile shaft and the hub acting in the circumferential direction, by means of which a rotary movement to drive the screw blade can be transmitted.

The linear drive unit can be used to drive the axial displacement of the profile shaft, the working element of which is connected to the profile shaft via the fastener. The connection to the profile shaft is made via the rotary bearing, in particular a rolling bearing, in such a way that the profile shaft is carried along with the displacement of the working element and the fastener without negatively affecting the rotation of the profile shaft about the effector axis. The linear drive unit is mounted on the end member of the articulated arm robot and therefore does not participate in a rotation of the output element of the articulated arm robot. For example, the articulated arm robot has six axes of rotation, wherein the effector axis is formed by the sixth axis of rotation and the output element is rotatable about the effector axis, and the end member is rotatable about the fifth axis of rotation.

In particular, the screw blade can be part of an interchangeable screw bit and the profile shaft has an end-sided bit holder. Alternatively, the profile shaft can be designed in one piece with the screw blade.

The device according to the invention can have a mouthpiece for providing a screw, wherein the mouthpiece is mounted on the end member of the articulated arm robot. The mouthpiece does not participate in the rotation about the effector axis nor in the axial displacement of the screw blade, so that the screwing process is not impaired or limited by the inert mass of the mouthpiece.

The fastener can have at least one driver, wherein the profile shaft and a shaft ring of the rotary bearing are actively connected to each other in the circumferential direction and in the axial direction by means of at least one driver. On the one hand, the driver is used to build a robust connection that can withstand fast screwdriving and displacement processes with high accelerations. The shaft ring is a shaft-side element of the rotary bearing, i.e., the shaft ring participates in the rotation of the profile shaft. The active connection between the at least one driver and the profile shaft is established in particular by means of a positive fit, wherein alternative types of connection, such as a welded connection, may also be suitable.

In particular, the use of at least one driver is necessary in a further embodiment of the device according to the invention, in which the inner diameter of the rotary bearing is greater than the outer diameter of the hub of the screwdriving tool unit, so that the rotary bearing encloses the hub circumferentially, wherein the hub has at least one axially running slot to accommodate at least one driver, so that the rotary bearing can be axially displaced relative to the hub while enclosing the hub. This enables a particularly compact design in which the profile shaft can lie completely inside the hub in a maximally retracted protective position. For example, the fastener has four pin-shaped drivers, each of which is rigidly arranged at a distance of 90° on the shaft ring of the rotary bearing, each forming a form-fitting connection with the profile shaft, with the hub having four corresponding slots to accommodate the drivers.

For example, the linear drive unit can be designed as a pneumatic cylinder or as an electromechanical linear drive unit. A control system of the linear drive unit ensures that the working element is appropriately shifted during the screwdriving process (propulsion) and when the screw blade is subsequently detached from the screw head (retraction).

The device according to the invention can have a gearbox, wherein the gearbox is actively connected to the output element and the screwdriving tool unit and is set up for the transmission of a speed between the output element and the screwdriving tool unit. The increase in the speed of the screwdriving tool unit that can be achieved with the high-speed transmission contributes to a further reduction in the achievable cycle time in the automated production of screwed connections.

Furthermore, the invention also relates to a method for the automated production of a screw connection by means of a device according to the invention according to any one of the aforementioned embodiments, wherein at least the following steps are carried out: shifting the profile shaft by means of the linear drive unit to a protective position in which the screw blade is retracted behind the mouthpiece; moving the articulated arm robot into a starting pose relative to the components to be screwed together; feeding a screw into the mouthpiece; shifting the profile shaft by means of the linear drive unit into an engagement position in which the screw blade is engaged with the screw; screwing in the screw while making the screw connection by turning the output element and driving the screw blade forward by shifting the profile shaft by means of the linear drive unit, and shifting the profile shaft to the protective position by means of the linear drive unit after the screw connection has been made.

In the method according to the invention, the concept quoted above of using the output element of the articulated arm robot for the (infinite) rotation of the screw blade is retained, i.e., that the articulated arm robot continues to act to drive the rotary movement of the screw blade by means of its output element, but no longer contributes to the simultaneous feed of the screw blade during the screwing process. Except for the rotation of the output element, the articulated arm robot remains motionless in the starting pose while the screw is screwed in. The axial displacement of the screw blade is carried out exclusively by means of the linear drive unit, which is much faster, more precise and more reproducible than a displacement by means of a complex robot movement. The cycle time per screw connection and the susceptibility to errors of the process can thus be significantly reduced. In particular, the screw blade can be avoided from snagging when it is released from the screw head.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a and 1b show a side and front view of a device according to the invention;

FIGS. 2a to 2c show associated cross-sectional views;

FIG. 3 shows a perspective view of the device in the protective position; and

FIGS. 4a to 4c show views of the device in an engagement position.

### DETAILED DESCRIPTION

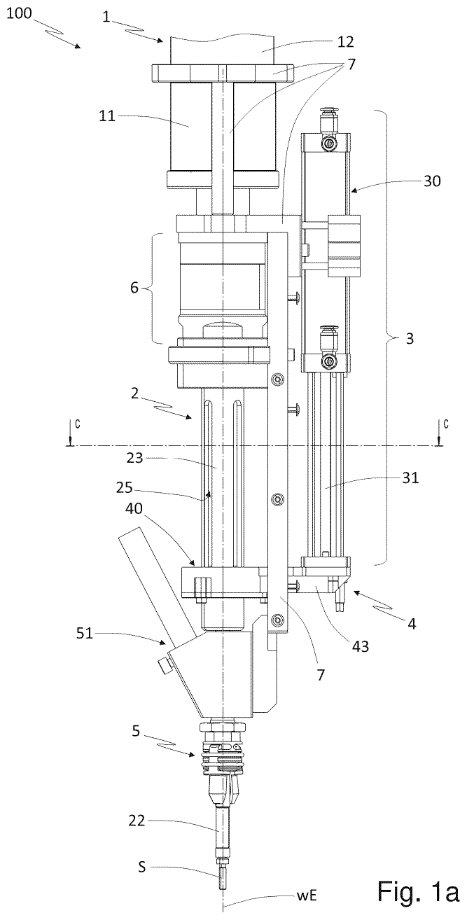

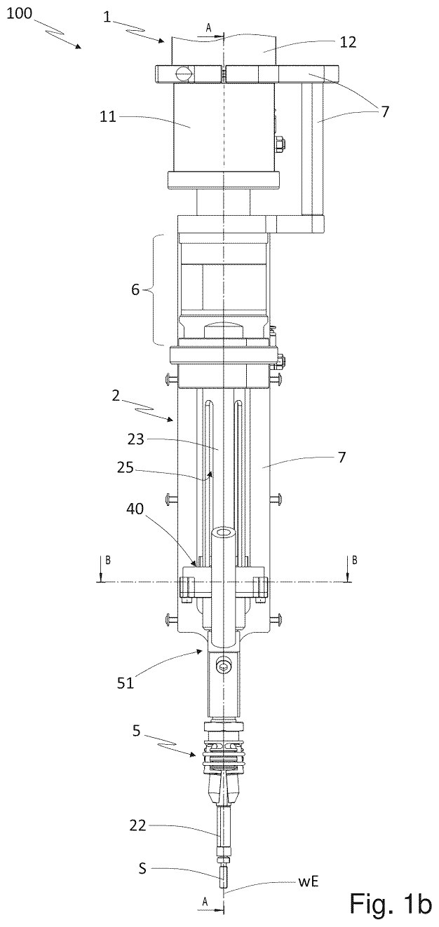

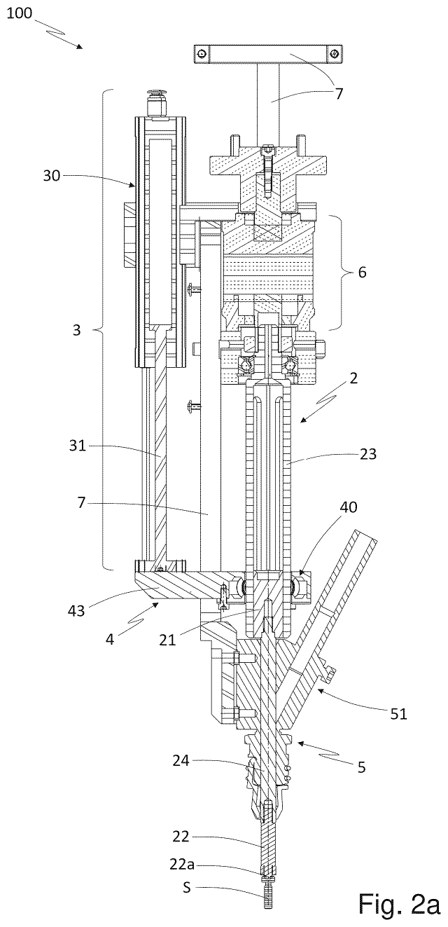

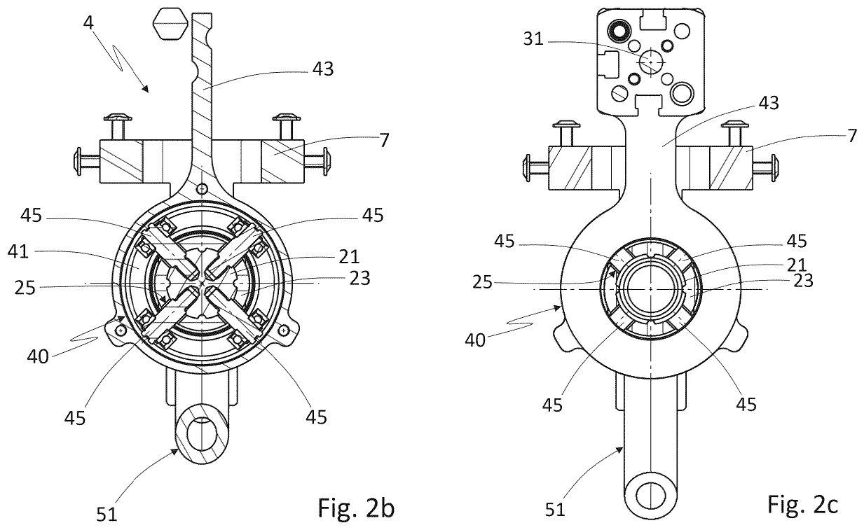

FIGS. 1a and 1b show a side and a front view of a device 100 according to the invention for the automated production of screw connections. Corresponding cross-sectional views are shown in FIG. 2a (corresponding to the section line AA in FIG. 1b), FIG. 2b (section line BB in FIG. 1b) and FIG. 2c (section line CC in FIG. 1a). The device 100 is shown in an engagement position in which the profile shaft 21 is shifted in the direction of the mouthpiece 5 and the screw blade 22a is engaged with the screw S.

The device 100 comprises the articulated arm robot 1, of which only the output element 11 and the end member 12 are shown in FIGS. 1a and 1b, wherein the output element 11 is arranged on the end member 12 so as to rotate about the effector axis wE. The articulated arm robot 1 is designed as a 6-axis robot.

The device 100 also includes the screwdriving tool unit 2, which can be rotated about the effector axis wE by means of the output element 11. The active connection between the output element 11 and the screwdriving tool unit 2 is formed by means of the gearbox 6, which is set up to transmit the robot-side speed to high-speed.

The screwdriving tool unit 2 comprises the profile shaft 21 with the screw bit 22 with the screw blade 22a arranged at the end of it via the bit holder 24, as well as the hub 23, wherein the profile shaft 21 and the hub 23 are connected to each other in a form-fitting manner in the circumferential direction, and wherein the profile shaft 21 can be shifted along the effector axis wE relative to the hub 23. The positive fit in the circumferential direction is established by means of the axial grooves of the profile shaft 21 visible in FIG. 2b and the spring-like structures in the inner profile of hub 23 that engage with them.

The linear drive unit 3, like the gearbox 6 and the mouthpiece 5, is mounted by means of the supporting structure 7 on the end member 12. The linear drive unit 3 is designed as a pneumatic cylinder 30 and the working element 31 can be driven pneumatically to an axial displacement parallel to the effector axis wE.

The fastener 4 is rigidly connected to the head side of the working element 31 with the cross member 43 and to the profile shaft 21 by means of the rotary bearing 40, so that the profile shaft 21 can be shifted along the effector axis wE by means of the linear drive unit 3.

The fastener 4 has the four pin-shaped drivers 45 (see FIGS. 2b and 2c), which are rigidly arranged at a distance of 90° each on the shaft ring 41 of the rotary bearing 40 and each form a form-fitting connection with the profile shaft 21, wherein the hub 23 has four corresponding slots 25 to accommodate the drivers 45. The profile shaft 21 and the shaft ring 41 are actively connected to each other in the circumferential direction and in the axial direction by means of the driver 45. The inner diameter of the rotary bearing 40 is greater than the outer diameter of the hub 23, so that the hub 23 is circumferentially enclosed by the rotary bearing 40. Due to the axially running slots 25 for the passage of the drivers 45, the rotary bearing 40 can be axially shifted relative to the hub 23. Thus, the hub 23 is not involved in an axial displacement of the profile shaft 21 by displacement of the working element 31 of the pneumatic cylinder 30. In a rotary movement driven by the output element 11 of the articulated arm robot 1, the entire screwdriving tool unit 2, i.e., both the profile shaft 21 including bit holder 24 and screw bit 22, as well as the hub 23, as well as the driver 45, participate.

The mouthpiece 5 with the feeding unit 51 for automated screw feeding is mounted via the support structure 7 on the end member 12 of the articulated arm robot 1.

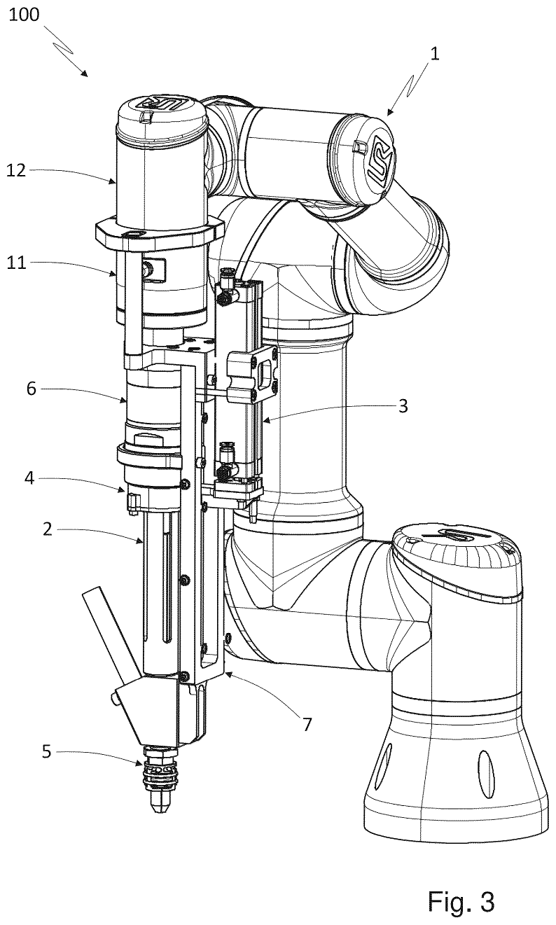

FIG. 3 shows a perspective view of the device 100 according to the invention, in which the articulated arm robot 1 is depicted in its entirety in the form of a 6-axis robot. The working element (31) of the linear drive unit 3 is completely retracted, so that the profile shaft (21) of the screwdriving tool unit 2 is shifted to a protective position in which the screw blade (22a) is retracted behind the mouthpiece 5.

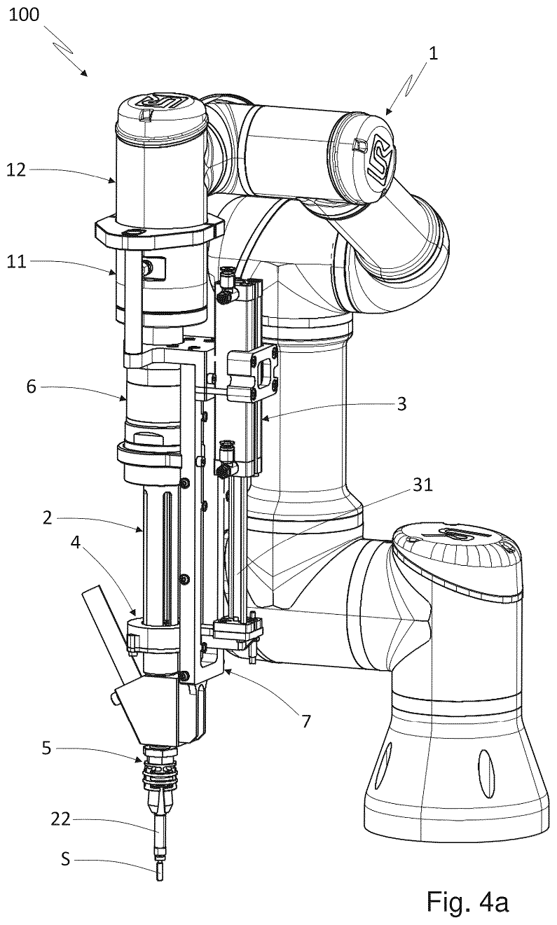

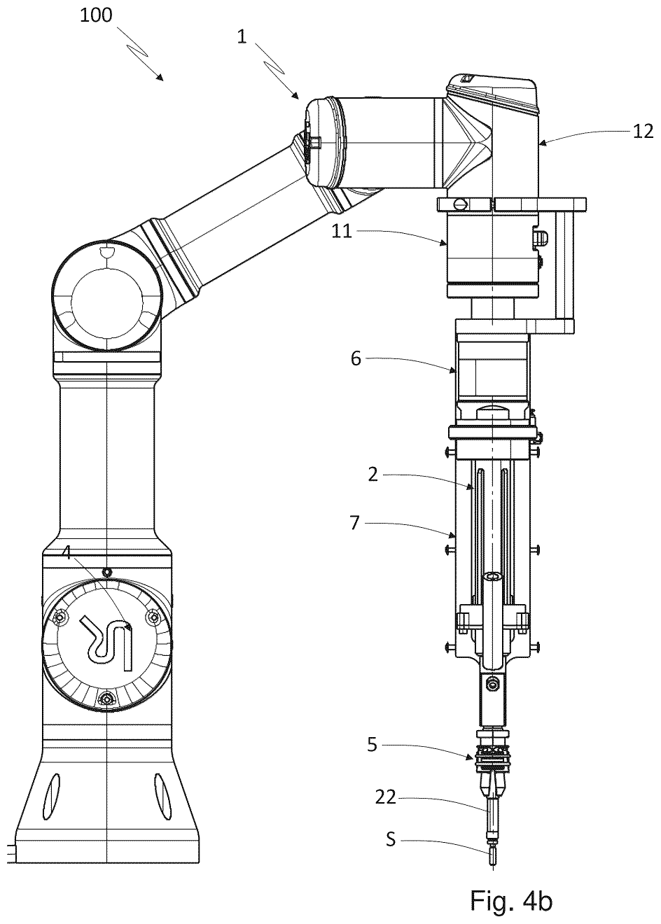

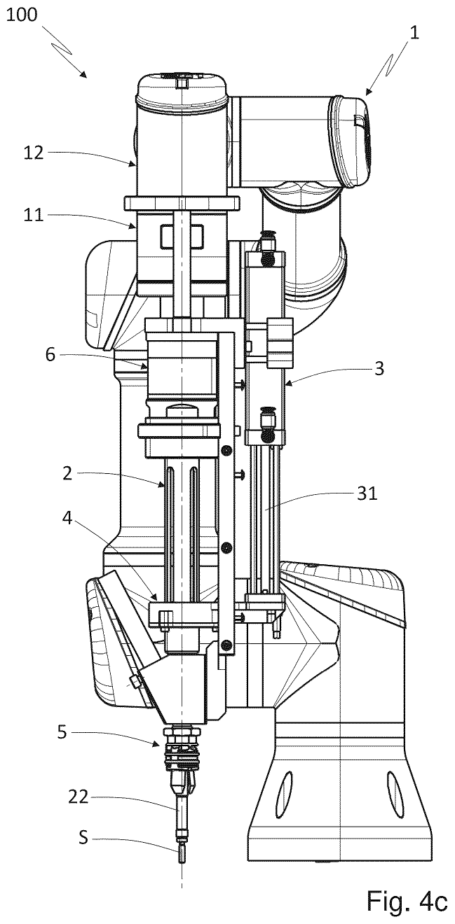

An engagement position of the profile shaft (21), in which the screw bit 22 has protruded from the mouthpiece 5 and the screw blade (22a) is engaged with the screw S, is shown in FIG. 4a (perspective view), FIG. 4b (side view) and FIG. 4c (front view). The working element 31 of the linear drive unit 3 is in a fully extended position. Only the linear drive unit 3 mediates between the positions shown in FIG. 3 and FIG. 4a-4c. Thus, the engagement of the screw blade (22a) with the screw S, the screwing in of the screw S forming a screw connection between components to be screwed, and the subsequent detachment of the screw blade (22a) from the screw S is carried out within the framework of the method according to the invention using the device 100 without changing the pose of the articulated arm robot 1.

The invention is not limited in its execution to the preferred embodiment given above. Rather, a number of variants are conceivable, which make use of the solution presented even in the case of fundamentally different designs. All features and/or advantages arising from the claims, the description or the drawings, including constructive details and spatial arrangements, can be essential to the invention both on their own and in the most diverse combinations.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for the automated production of screw connections, the device comprising:
an articulated arm robot having an output element and an end member, the output element being arranged on the end member so as to be rotatable about an effector axis;
a screwdriving tool unit that is rotatable about the effector axis via the output element, the screwdriving tool unit comprising a profile shaft with a screw blade arranged at the end of it and a hub, the profile shaft and the hub are connected to each other in a form-fitting manner in a circumferential direction, the profile shaft being adapted to be displaced relative to the hub along the effector axis;
a linear drive unit mounted at the end member, the linear drive unit comprising a working element adapted to be driven to an axial displacement parallel to the effector axis; and
a fastener rigidly connected to the working element and connected to the profile shaft via a rotary bearing so that the profile shaft is adapted to be displaced along the effector axis via the linear drive unit.

2. The device according to claim 1, further comprising a mouthpiece to provide a screw, wherein the mouthpiece is mounted on the end member.

3. The device according to claim 1, wherein the fastener has at least one driver, wherein the profile shaft and a shaft ring of the rotary bearing are actively connected to each other in the circumferential direction and in the axial direction via at least one driver.

4. The device according to claim 3, wherein the inner diameter of the rotary bearing is greater than the outer diameter of the hub of the screwdriving tool unit so that the rotary bearing encloses the hub, wherein the hub has at least one axially running slot to accommodate at least one driver so that the rotary bearing is adapted to be axially displaced relative to the hub while enclosing the hub.

5. The device according to claim 4, wherein the fastener comprises four pin-shaped drivers, which are rigidly arranged at a distance of 90° each on the shaft ring of the rotary bearing and each form a form-fitting connection with the profile shaft, wherein the hub has four corresponding slots to accommodate the drivers.

6. The device according to claim 1, wherein the linear drive unit is a pneumatic cylinder or as an electromechanical linear drive unit.

7. The device according to claim 1, wherein the device has a gearbox, wherein the gearbox is actively connected to the output element and the screwdriving tool unit and transmits a speed between the output element and the screwdriving tool unit.

8. A method for the automated production of a screw connection via the device according to claim 1, the method comprising:
shifting the profile shaft by the linear drive unit to a protective position in which the screw blade is retracted behind the mouthpiece;
moving the articulated arm robot into a starting pose relative to the components to be screwed together;
feeding a screw into the mouthpiece;
shifting the profile shaft via the linear drive unit into an engagement position in which the screw blade is engaged with the screw;
screwing in the screw while making the screw connection by turning the output element and driving the screw blade forward by displacing the profile shaft via the linear drive unit; and
shifting the profile shaft via the linear drive unit to the protective position after the screw connection has been made.
